(19) United States
(12) Patent Application Publication
(10) Pub. No.: US 2015/0113806 A1
(43) Pub. Date: Apr. 30, 2015

(54) METHOD FOR FILLING A HEAT STORAGE TANK WITH SOLID ELEMENTS

(71) Applicant: Commissariat à I'énergie atomique et aux énergies alternatives, Paris (FR)

(72) Inventors: Raphaël Couturier, Sassenage (FR); Arnaud Bruch, Sainte Colombe les Vienne (FR); Jean-François Fourmigue, Fontaine (FR)

(21) Appl. No.: 14/399,640

(22) PCT Filed: May 6, 2013
(86) PCT No.: PCT/EP2013/059404

§ 371 Date: Nov. 7, 2014

(30) Foreign Application Priority Data
May 9, 2012 (FR) 12 54226

(51) Int. Cl. B23P 15/26

(52) U.S. Cl. CPC B23P 15/26
USPC 29/890.03

(57) ABSTRACT

Method for filling a heat storage tank with solid elements having at least one first particle size greater than at least one second particle size, the method includingthe following steps: a) pouring a first quantity of solid elements of the first particle size into the tank, b) levelling said first quantity of solid elements of the first particle size so as to form a layer of a substantially constant height, c) pouring a second given quantity of solid elements of the second particle size over the layer of solid elements of the first particle size such that the solid elements of the second particle size flow between the solid elements of the first particle size and such that the elements of the second particle size are flush with the layer of the solid elements of the first particle size and so as to form an intermediate layer.

### TECHNICAL FIELD AND PRIOR ART

The present invention relates to a method for filling a heat storage tank with solid elements.

Numerous fields and numerous industrial applications implement the storage of heat. The storage of heat enables the valorisation of heat stemming from industrial processes, the recovery of surplus energy or dissociating the moment of production of thermal energy from the use thereof.

As an example, in the CSP field (CSP designating “Concentrated Solar Power”), the surplus heat produced at times of strong sunshine may thus be stored so as to be exploited at the end of the day.

The storage of heat may typically be realised either in the form of sensitive energy (by varying the temperature level of a solid or liquid storage material), in the form of latent energy (by changing the phase of a storage material) or finally in the form of chemical energy (using endothermic and exothermic chemical reactions).

In the case of sensitive heat storage, the heat is stored by raising the temperature of a storage material which may be liquid, solid or a combination thereof.

Industrial processes involving a use or a conversion of thermal energy by means of a thermodynamic cycle, for example by the use of a steam turbine, involve overall two temperature levels which are the conditions at the limits of the cycle. It is sought to maintain these two temperature levels as constant as possible in order to obtain optimised operation of the cycle. In fact, as an example, steam turbines, which assure the conversion of thermal energy into electrical energy, have higher efficiency when the input temperature in the turbine is maintained constant at a predefined value. Consequently, storage associated with such systems must thus respect these characteristics and make it possible for example to destore heat at a constant temperature level.

An example of this type of operation is the field of concentrated solar power where a typical storage system consists of two tanks filled with storage fluid at two temperature levels. One of the tanks stores at a constant low temperature and the second storage tank at a constant high temperature. The output temperature of the hot tank is thus constant throughout destorage.

Systems only comprising a single tank containing both the hot fluid and the cold fluid also exist. There then exists thermal stratification within the tank, the hot fluid situated in the upper part and the cold fluid situated in the lower part are then separated by a transition region known as “thermocline”.

The use of a single tank makes it possible to reduce the number of components, such as pumps, valves, etc. and to simplify command-control.

In thermocline type storage, the storage material may be a heat transfer liquid or, advantageously, a mixture of a heat transfer fluid and a cheap solid material. The use of such a solid material furthermore makes it possible to improve the segregation of the hot fluid and the cold fluid while reducing remixing effects. In the latter case, this is then referred to as “dual thermocline” (or “mixed-media thermocline”).

This “dual thermocline” tank has the advantage of reducing the quantity of liquid necessary, given that solid rock type materials are cheap, the total cost is reduced.

In a thermocline tank, in order to take account of density differences and to avoid natural convection movements, the heat transfer fluid is introduced via the top of the tank during storage phases and via the bottom of the tank during destorage phases. Storage is thus characterised by a hot zone at the top of the vessel, a cold zone at the bottom and a transition zone between the two zones known as a thermocline. The principle of this type of heat storage is to create a “heat piston”, that is to say the advance of a thermal front that is as thin as possible and uniform transversally. This makes it possible to maintain constant temperatures during charge and discharge phases.

During charge phases, cold liquid is removed from the tank via the bottom and is heated, for example by passing through a heat exchanger of a solar collector, and then sent back into the tank via the top. During discharge phases, hot liquid is removed from the tank via the top, and is sent for example to the evaporator of a thermodynamic cycle incorporating a turbine, in which it is cooled and is then sent back into the tank via the bottom. During charge and discharge phases the heat piston moves downwards and upwards respectively.

“Dual thermocline” type storage based on a mixture of liquid heat transfer fluid and solid matrix brings into play very low fluid velocities of the order of several mm/s in order to assure the transfer of heat between the fluid and the static charge and to limit inhomogeneities.

In real operation, such a storage system has inhomogeneities and the heat piston is not perfect. These inhomogeneities can stem from, for example, inhomogeneities in the distribution of the static charge, formed for example of a mixture of rocks and sand, which may be linked to the initial filling of the storage tank during which for example a segregation between the pieces of rock and grains of sand can occur, or to the thermal cycling of the solid matrix which “comes alive” during thermal expansions and contractions of the tank. “Rock” and “sand” are two terms to define granular media with large and small diameter respectively consisting of mineral particles.

These inhomogeneities lead to the appearance of preferential paths, with chimney effects which degrade the heat piston operation and restrict the correct operation of the thermocline. In charge phase, it may happen that there are hot “tongues” progressing in the cold fluid. A high temperature disparity then appears in a transversal plane of the tank.

This degraded behaviour of the tank is not very compatible with the thermal/electric conversion units used in concentrated solar power plants, the correct operation of which requires an input temperature that is as constant as possible. A variable input temperature leads to a drop in the conversion efficiency or even to going out of the acceptable operating range.

The American Solar One solar power plant project conducted in the 1980s is associated with a heat storage tank, in which the solid material is formed of a bed of rock comprising a mixture composed of 7/11th of rock and 4/11th of sand. This bed of rock is produced by filling the tank with a pre-mix of rock and sand then packing down this pre-mix. After filling, a porosity of 23% is present. It appears that this mixing prior to filling is not satisfactory. This is because, during filling, moving particles of different sizes bring about preferential movements of particles and, in the case of pre-mixing in a drum, the segregation of fine particles towards the centre. This is for example illustrated in FIG. 1.5 of the PhD thesis entitled “Ecoulement de particules dans un milieu poreux” (Flow of particles in a porous medium) by F Lorainé defended on the 19 Oct. 2007 at the Université de Rennes 1.

Consequently, prior to filling the mixture is already not homogeneous.

Moreover, during filling segregation also arises while pouring out of the pre-mix. The particles with the largest size are found preferentially on the edge of the pile that forms. In fact, the larger the grains the more the surface of the pile seems smooth to them. The dissipation of energy is thus slower and they cover a greater distance before stopping. This is illustrated by FIG. 1.7 of the aforementioned PhD thesis. In this type of distribution, the fluid encounters on the edges of the tank zones that are very low in sand, conversely at the centre of the tank the bed of rock is formed almost exclusively of fine sand. In the case of a “dual thermocline” type heat tank, this leads to a preferential circulation of the oil on the edges of the tank, the centre constituting a “dead” zone vis-à-vis heat storage.

Finally, a risk of additional segregation exists during packing down. This is because such a packing down is generally carried out by vibrating the bed of rock, which certainly makes it possible to slightly increase compactness but can cause segregation between the large particles and the small particles according to a well-known phenomenon. The large particles rise to the surface of a bed of grains subjected to vibration. This is because the small particles percolate into the voids left underneath the large grains.

Consequently the method for filling the tank of the Solar One project is not satisfactory for optimal operation of the heat storage tank.

### DESCRIPTION OF THE INVENTION

It is consequently an aim of the present invention is to offer a method for filling a “dual thermocline” type heat storage tank with solid heat storage elements comprising at least two types of solid elements of different sizes making it possible to obtain a homogeneous distribution of the elements in the tank, thereby assuring correct operation of the tank.

The aim of the present invention is attained by a method for filling a heat storage tank with solid elements having at least one first size and one second size, the first size being greater than the second size, the method comprising a first step of placing solid elements of the first size in the tank, a second step of levelling the layer of solid elements of the first size thereby formed so as to obtain a layer of substantially constant thickness, a third step of filling with solid elements of the second size the spaces between the solid elements of the first size until it comes flush with the layer of the solid elements of the first size, the first, second and third steps being optionally repeated until the desired height of solid elements is reached.

Each particle size corresponds to a diameter d50 of solid elements, defined as the value for which 50% of the solid elements have a diameter less than d50. The diameter d50 also designates the median.

In other words, the solid elements are poured out successively one on top of the other, beginning with those having a first particle size, the median of which is the largest, and in the order of decreasing medians.

In a very advantageous manner, a ratio comprised between 8 and 20 is chosen between the median of the solid elements of the first size and the median of the solid elements of the second particle size. Such a ratio makes it possible to obtain a relatively low porosity of the bed of solid elements. In a preferred manner, this ratio is of the order of 10.

Preferably, the material(s) of the solid elements are chosen so as to have a high density and a high heat capacity in order to offer good heat storage capacity.

Also preferably, the material(s) of the solid elements have low porosity which reduces the quantity of gas to degas during the first heatings of the tank.

The method for filling according to the invention is particularly suited to the filling of storage tanks in which the solid charge is spread out in several stages, further improving the heat piston operation of the tank and the supply of a liquid at constant temperature.

The present invention therefore relates to a method for filling a heat storage tank with solid elements having at least one first particle size and one second particle size, the first particle size being greater than the second particle size, said method comprising the following steps:

a) pouring a first quantity of solid elements of the first particle size into the tank,

b) levelling said first quantity of solid elements of the first particle size so as to form a layer of substantially constant height,

c) pouring a second given quantity of solid elements of the second particle size over the layer of solid elements of the first particle size such that the solid elements of the second particle size flow by gravity between the solid elements of the first particle size and such that the elements of the second particle size are flush with the layer of the solid elements of the first particle size and so as to form an intermediate layer.

The method for filling may comprise a step d) of levelling the second quantity of solid elements of the second particle size.

Steps a) to c) or a) to d) may be repeated so as to form a stack of intermediate layers until a given height of solid elements in the tank is reached.

Advantageously, the ratio between the median of the first particle size and the median of the second particle size is comprised between 8 and 20 and is in a preferred manner of the order of 10.

During step c) the solid elements of the second particle size are for example spread out over the whole layer of solid elements of the first particle size.

The intermediate layer may have a height of the order of 15 cm.

Preferably, prior to step a) the solid elements of the first particle size are washed and dried.

Also preferably, prior to step c) the solid elements of the second particle size are washed and dried.

Advantageously, the first quantity corresponds to around 80% by weight of the intermediate layer and the second quantity corresponds to around 20% by weight of the intermediate layer.

The present invention also relates to a method for manufacturing a heat storage tank comprising the following steps:
manufacturing an assembly formed of a collar and a lower end,
filling according to the method according to the present invention,
putting in place an upper end to seal the tank in a leak tight manner,
filling with the heat transfer fluid.

In one embodiment, the tank comprises at least two superposed compartments, each compartment comprises a bed of solid elements, each compartment being filled according to the method according to the present invention

The solid elements of the first particle size are for example alluvial pebbles and the solid elements of the second particle size are for example silica based sand.

The heat transfer fluid is for example thermal oil, for example Therminol 66®.

### BRIEF DESCRIPTION OF THE DRAWINGS

The present invention will be better understood by means of the description given hereafter and the appended drawings in which:

FIGS. 1A to 1C are schematic representations of different steps of the method for filling according to the invention,

FIG. 2 is a longitudinal sectional view of an example of embodiment of a heat storage tank to which the method for filling according to the invention applies,

FIG. 3A is a longitudinal sectional view of another example of embodiment of a heat storage tank to which the method for filling according to the invention applies,

FIGS. 3B and 3C are top views of an example of embodiment of supports intended to delimit the compartments in the tank of FIG. 3A,

FIG. 3D is a sectional view along the plane A-A of FIG. 3B,

FIG. 4A is a longitudinal sectional view of a layer of solid elements obtained by a filling method of the prior art,

FIG. 4B is a graphic representation of the variation in temperature and the local velocity of the oil in the layer of FIG. 4A as a function of the distance with respect to the axis of the tank,

FIG. 5 is a top view of an example of embodiment of a distributor that can be implemented in the tank of FIG. 2 or of FIG. 3A,

FIG. 6 is a graphic representation of the cumulated percentage by weight as a function of the diameter in mm of the particles of an example of solid elements of the second particle size that can be used in the filling according to the present invention.

### DETAILED DESCRIPTION OF PARTICULAR EMBODIMENTS

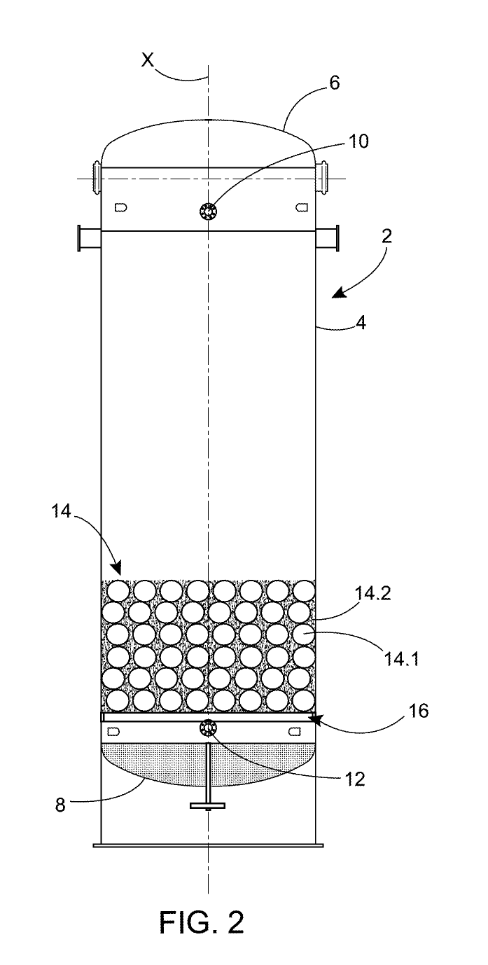

In FIG. 2 may be seen a longitudinal sectional view of an example of heat storage tank to which the method for filling according to the invention applies.

The tank comprises a cylindrical envelope 2 with a longitudinal axis X. In the example represented, the tank has a circular section.

The longitudinal axis X is intended to be oriented substantially vertically.

The envelope 2 is formed of a collar 4 and two convex ends 6, 8 closing the upper and lower longitudinal ends respectively of the collar 4.

The tank comprises means for admitting and collecting 10 hot liquid situated in the upper convex end 6 of the tank and means for admitting and collecting 12 cold liquid situated in the lower convex end 8 in the lower part of the tank.

The tank comprises a bed 14 of solid heat storage elements arranged between the means for admitting and collecting 10 hot liquid and the means for admitting and collecting 12 cold liquid. In FIG. 2, the bed 14 is represented partially.

The bed of solid elements 14 rests on a grate or perforated plate 16 arranged above the means for admitting and collecting 12 cold liquid. The liquid may then pass through the grate 16 and the admitting and collecting means 12 do not support the bed 14.

The useful volume of the tank does not comprise any void zone, such that the volume not occupied by the solid elements is filled by the heat transfer fluid.

In the example represented, the solid heat storage elements comprise solid elements 14.1 of a first particle size and solid elements 14.2 of a second particle size.

The solid elements are considered as having a shape approximating a sphere. Each particle size corresponds to a diameter d50 as defined above and designated median, the median of the first particle size being greater than the median of the second particle size.

For example, the solid elements of the first particle size 14.1 are formed of blocks of rock and the solid elements of the second particle size 14.2 are formed of sand.

Preferably, the ratio between the medians of the elements of first particle size 14.1 and the elements of second particle size is comprised between 8 and 20, and in a preferred manner is of the order of 10. Such ratios make it possible to have reduced residual porosity of the mixture, for example of the order of 30%.

The method for filling comprises the following steps.

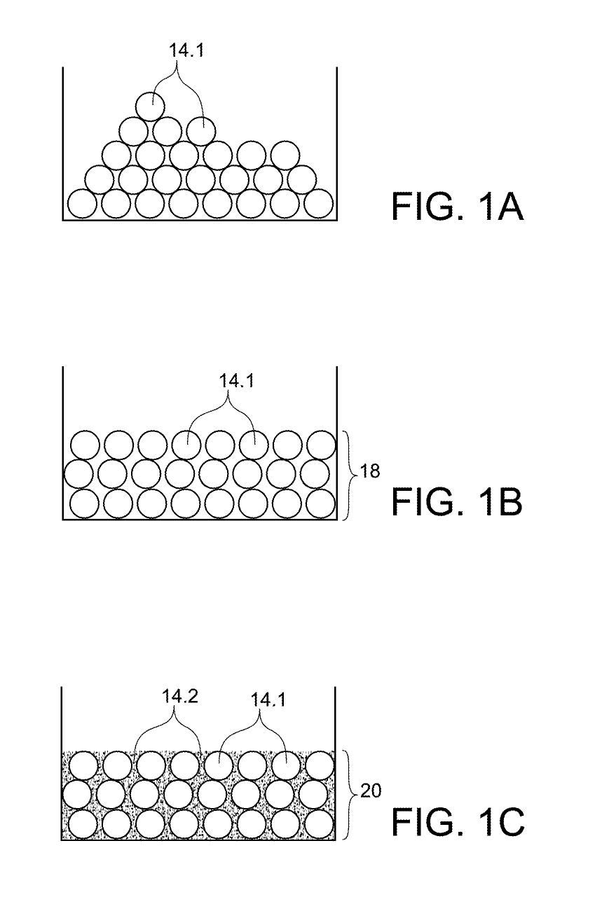

During a step a), a first quantity of solid elements of the first particle size 14.1 is poured inside the tank onto the grate 16. The solid elements of the first particle size 14.1 then form a pile at the centre of the grate 16. This step is represented in FIG. 1A. It is possible to spread out the elements 14.1 on the grate 14 during pouring so as to limit the formation of a pile and to link up a layer of more homogeneous thickness.

During a following step b), the pile is levelled so as to form a layer 18 of substantially constant height over the whole section of the tank. The levelling may be done either manually for example using a rake or by a motorised device. This step is represented in FIG. 1B.

During a following step c), a given quantity of solid elements of the second particle size 14.2 is poured over the layer 18. The solid elements 14.2 naturally flow by gravity between the solid elements 14.1 and fill the spaces between the solid elements 14.1 of first particle size.

The given quantity of solid elements of the second particle size 14.2 is chosen such that the solid elements of the second particle size 14.2 are flush with the layer 18. A layer 20 composed of solid elements of the first particle size 14.1 and the second particle size 14.2 is formed. This step is represented in FIG. 1C.

Preferably, the weight of solid elements of the second particle size 14.2 represents around 20% of the bed 14.

The addition of the solid elements of the second particle size 14.2 can take place manually or through the intermediary of a hopper.

Preferably, the solid elements of the second particle size 14.2 are poured out so as to spread them out over the whole surface of the solid elements of the first particle size 14.1.

The thickness of the layer 18 is determined such that the solid elements of the second particle size 14.2 easily penetrate between the solid elements of the first particle size 14.1

Preferably, the layer 18 of solid elements of the first particle size 14.1 is of the order of 15 cm.

During a following step d), a levelling of the solid elements of the second particle size 14.2 is carried out so as to obtain a layer 20 having a substantially constant height.

Step d) may not take place if during the pouring of the solid elements of the second particle size 14.2, the layer 20 directly has a sufficiently constant height.

Steps a) to d) are then repeated until the bed 14 is formed.

During the filling, in particular during step c), there is neither packing down, nor mechanical action, the penetration of the solid elements of the second particle size between the interstices formed by the elements of the first particle size and the filling of the interstices by the solid elements of the second particle size are obtained uniquely by the effect of particle size.

Prior to filling, the solid heat storage elements 14.1 are advantageously washed, in order to limit the presence of fine dusts which could otherwise circulate with the heat transfer fluid.

Preferentially, the solid elements are dried. This drying makes it possible to limit the quantity of water introduced into the tank with the solid elements, water which is degassed during the heating of the storage. Moreover, the drying of the elements 14.2 of small diameter facilitates their flow between the elements 14.1.

At the end of filling, the upper end 6 of the vessel is put in place and tightened with a gasket. The oil is then introduced into the tank by the lower collection and admission means 12. The oil rises in the bed and expels the air contained in the free spaces left by the solid elements.

The method for filling according to the invention by successive layers assures very good homogeneity of the mixture at the scale of the tank. In fact, there is no substantial difference between the core of the bed 14 and its periphery. At a local scale, all the zones have substantially the same proportion of solid elements of the second particle size 14.2.

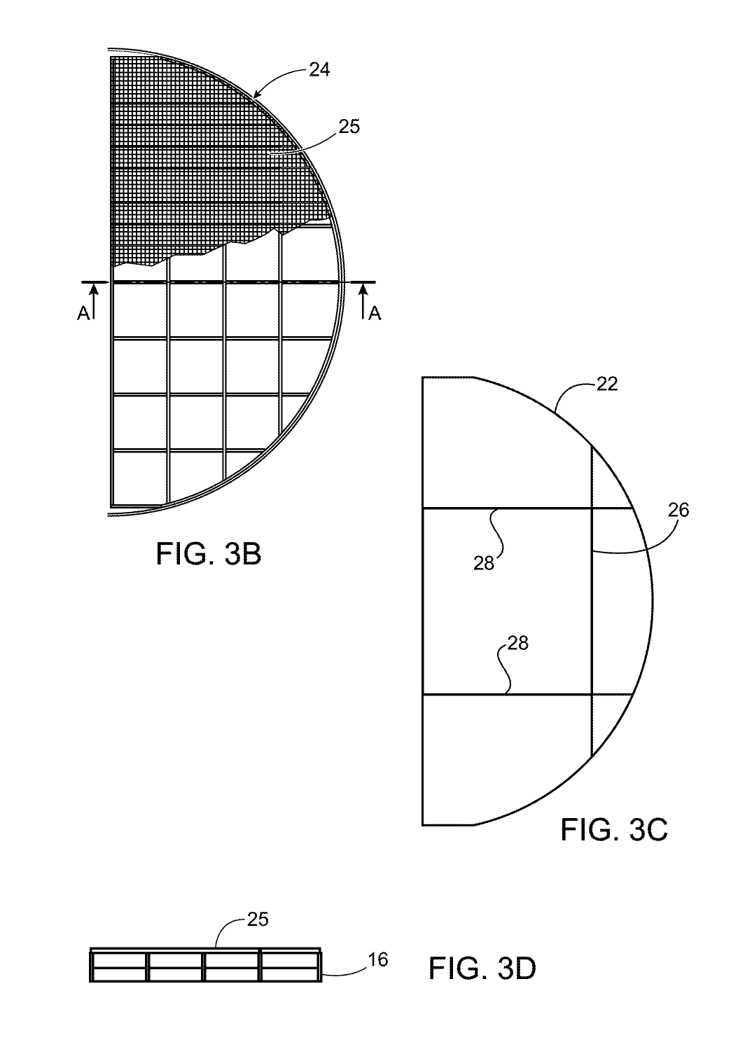

In FIG. 4A may be seen represented schematically in longitudinal section a theoretical outline of a volume element of a bed 14′ formed of two zones Z1, Z2 having different proportions of solid elements of the second particle size 14.2. The x-axis represents the distance r in a transversal plane along a radius. This volume element could be situated in different zones of the tank.

This bed is obtained by pouring a mixture of solid elements of the first particle size 14.1 and solid elements of the second particle size 14.2. Naturally segregation arises between the elements 14.1 and 14.2.

In FIG. 4B, are represented the variation in temperature in ° C. and the velocity of the thermal front in m/s within the volume element of 14′ of FIG. 4A.

Due to the low proportion of solid elements of the second particle size 14.2 in the zone Z1 the flow velocity is high compared to that in the zone Z2. As a result, the temperature in the zone Z1 varies whereas in the zone Z2 it is substantially constant. The zone Z1 is thus a zone of preferential flow, which leads to a transversal destabilisation of the thermal front. When the flow velocity is too high, the heat storage capacity of the solid elements of the first particle size is not used in a sufficient manner.

Thanks to the method for filling according to the invention the bed 14 has the distribution of the zone Z2, and the temperature which is then delivered by the tank is substantially constant.

The bed may be formed with solid elements having more than two different particle sizes, for example three. It will be noted that the minimum particle size is chosen such that the solid elements having the minimum particle size are not carried along by the heat transfer liquid, which could block the admitting and collecting means 10, 12.

In the case where solid elements of three different particle sizes are implemented to form the bed, the method comprises at least one step e) following step d) in which the solid elements of the third particle size are poured over the layer 20 and then levelled.

In a preferential manner, the solid elements and more particularly the solid elements of the first particle size 14.1 having a large diameter are chosen so as to have a low porosity. Thus the quantity of the gas or gases, which cannot interact with the heat transfer fluid and which is evacuated before the filling of the tank with the heat transfer fluid, is reduced. It may be water contained in the solid elements, air or any other chemical species.

Preferably, the material(s) of the solid elements are chosen so as to have a high density and a high heat capacity in order to offer good heat storage capacity. Also preferably, the material(s) of the solid elements have low porosity which reduces the quantity of gas to degas.

The material(s) of the solid elements are chosen such that they do not bring about interactions with the heat transfer fluid: for example for an oil storage, alluvial rocks rich in silica are suitable.

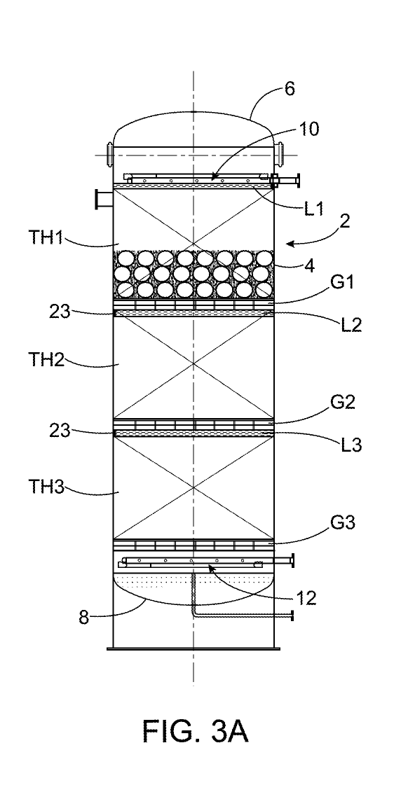

In FIG. 3A may be seen another example of embodiment of a tank for which the method for filling according to the present invention is particularly suited.

The inside of the tank is divided into several compartments C1, C2, C3 superposed along the longitudinal axis X. Each compartment C1, C2, C3 comprises an end G1, G2, G3 forming support assuring the retention of the solid heat storage elements while enabling fluid communication between the compartments and a bed TH1, TH2, TH3 of solid heat storage elements. Only the bed TH1 is represented by solid elements.

Moreover, a layer of heat transfer liquid L2, L3 covers the beds TH2, TH3 of solid heat storage elements.

The zone situated above the bed TH1 and delimited by the convex end 6 is filled with liquid. Similarly the zone situated under the bed TH3 delimited by the lower convex end 8 is filled with liquid.

The supports are thus adapted to support mechanically the heat storage beds, to retain the elements of low particle size, such as sand, and to allow the heat transfer liquid to pass through.

In FIGS. 3B to 3D may be seen details of a support F1 according to one embodiment example.

Advantageously the support G1 is formed of two half-supports facilitating its mounting in the collar 4. A support in one piece may also be implemented.

In FIGS. 3B and 3C may be seen a bearing structure 22 in the shape of a half-disc, and a slatted structure 24 in the shape of a half-disc covered with a grate 25 resting on the bearing structure 22.

The bearing structure 22 is formed of parallel bearing bars 26 secured to one another by cross-pieces 28 and forming a structure in the shape of a half-circle.

In FIG. 3D may be seen a sectional view along the plane A-A of FIG. 3B of the slatted structure 24 and the grate 22.

The grate 22 is for example formed of a metal screen in which the mesh size is such that it assures the retention of the solid elements of the smallest particle sizes.

The supports G1, G2, G3 suspended in the collar are supported for example on lugs fixed to the inner surface of the collar.

The admitting and collecting means 10, 12 comprise preferably an orifice for collecting the hot and cold fluid respectively and distribution means for supplying the tank with hot and cold fluid respectively.

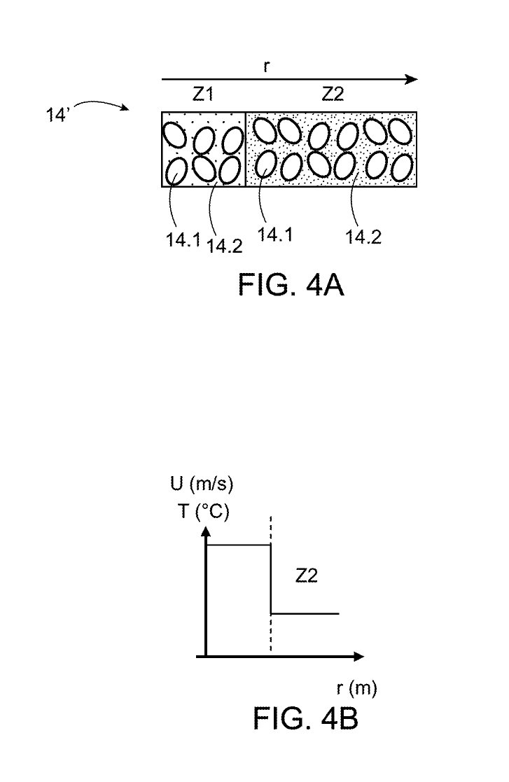

In FIG. 5 may be seen an advantageous example of embodiment of means of distribution of hot liquid in the tank of FIG. 3A seen from the top.

The distribution means 30 comprise a supply duct 32 connected to the external liquid supply and distribution ducts 34 connected to the supply duct and extending transversally with respect thereto. In the example represented, the distribution ducts 34 are perpendicular to the supply duct 32. Each duct is provided with a plurality of distribution orifices assuring a distribution of the liquid along its axis.

The main duct extends advantageously along a diameter of the collar. Also advantageously, the distribution ducts have different lengths as a function of their position along the main duct such that the distribution means cover in a substantially homogeneous manner the entire transversal section of the collar.

Other forms of distribution means may be envisaged, preferably these forms assuring a homogeneous distribution of the liquids supplying the tank.

Each compartment is filled according to steps a) to d) of the method according to the present invention. The grate G3 is put in place beforehand at the bottom of the tank and the compartment C3 is filled according to steps a) to d), then the support G2 is put in place in the collar, the compartment C2 is filled according to steps a) to d), the support G1 is put in place and the compartment is filled according to steps a) to d).

For example, the tank of FIG. 3A has a diameter of 2500 mm, three compartments of which the height of each bed is 1900 mm, a thickness of the liquid layer of 100 mm and an operating temperature comprised between 150° C. and 300° C.

To assure mechanical strength, it is sought to have a height of bed to diameter of bed ratio less than 1.

The segmentation of the bed of solid elements makes it possible to attain, for each compartment, a height of heat storage bed to diameter of the collar ratio less than 1 which makes it possible to reduce the effect of thermal ratcheting and thus to assure good mechanical strength. And, simultaneously, segmentation makes it possible to have a considerable total height of solid element bed and thus a high total height to diameter ratio. Important storage properties in terms of duration and volume of isothermal zone are thereby obtained.

Moreover, this structure of tank assures that in the case of transversal temperature inhomogeneities, temperature gradients and thus liquid density gradients arise in the liquid layers, which leads to the appearance of natural convection movements which tend to reduce this gradient. Thus, by combining the structure of the tank of FIG. 3A and the method for filling according to the invention, the operation of the tank is substantially improved.

An example of the operation of a heat storage tank will now be described.

After filling the tank with heat transfer liquid, for example oil, preferably successive temperature rise steps are carried out in order to degas as best as possible the bed of solid elements.

The hot oil is delivered by the upper collection and admission means 10.

During a first step, the whole of the bed is heated to 60° C. with this temperature being maintained for at least 4 h in order to extract from the bed the air residues contained in the porosities at a temperature where the oil does not oxidise.

During a following step, the temperature is raised to 120° C.-130° C. for several hours in order to degas the steam. The temperature is greater than 100° C. because it corresponds to the water saturation temperature under the hydraulic pressure at the bottom of the vessel. During this stage, the steam is evacuated via a purge situated on the upper lid of the tank. Preferably, this operation is carried out slowly in order to avoid a too important increase in pressure in the tank.

During a following step, the temperatures are increased successively with each temperature being maintained for one to several hours, it may be a stage of 30° C., up to the maximum temperature in order to degas the volatile elements of the oil. This maximum temperature is 300° C. for the oil Therminol 66®.

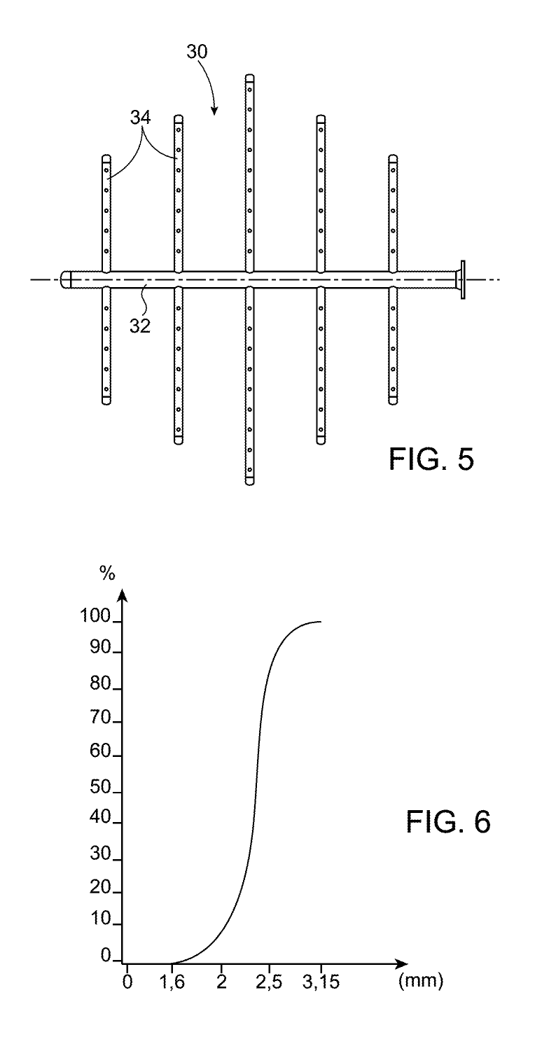

As an example, the solid elements of the first particle size 14.1 are alluvial pebbles consisting very mainly of silica of average diameter of 2.5 cm. The pebbles are obtained by sieving of alluvial quarry rocks, for example using a sieve with a mesh size of 20 mm and 30 mm. The solid elements of the second particle size 14.2 are sand comprising silica based particles (typical composition 87% SiO₂, 6% Al₂O₃, 3% K₂O) of average diameter close to 2.5 mm. In FIG. 6 is represented the cumulative percentage by weight as a function of the diameter in mm of the particles.

The bed 14 comprises 20% by weight of sand, which makes it possible to attain a porosity of the bed of rock of around 30%. The pebbles and the sand have a density of around 2500 kg/m³.

Thanks to the method for filling according to the present invention, a thermal stratification of good quality is obtained with very good transversal temperature homogeneity. The useful proportion of the heat tank is thus increased and an improved operation of the storage system, which then comes close to heat piston operation, is obtained.

Furthermore, due to this homogeneous distribution of the elements of different particle size, the risks of hydraulic short-circuits arising along the walls or dead zone, which would not participate in thermal exchange at the centre, are considerably reduced. The totality of the tank is then used for heat storage.

Moreover, since the heat piston operation is improved, maintaining a constant temperature at the outlet of the tank is favoured and thus a good efficiency and better lifetime of the system, for example a turbine, to which the tank supplies heat during destoring.

Moreover, thanks to filling by successive layers, it is possible to arrange thermocouples at different points of a section of the storage bed and in several sections of the bed, which makes it possible to measure the temperature of the oil at the core of the bed. It may be envisaged to arrange thermocouples in the rocks by drilling them. These temperature measurements, especially those at the core of the rocks, make it possible to monitor the advance of the thermal front and to check that heat transfer between the heat transfer liquid and the rocks is optimal. If the transfer is good, a low thermal gradient is measured between thermocouples close together in the heat transfer liquid and in the rock. This also makes it possible to adapt the flow rate of heat transfer fluid as a function of the behaviour actually observed at different heights of the bed of solid elements.

Thanks to the method for filling, resorting to vibrating the tank is also avoided, which simplifies the filling of the tanks and enables filling of tanks of large size.

The method for filling according to the invention is especially particularly suited to the manufacture of tanks for the storage of heat produced by Fresnel or cylindrical-parabolic type concentrated solar power plants, but also tower solar power plants.

This method for filling is also suited to the manufacture of heat storage tanks requiring controlled and constant temperatures at the discharge of the tank.

What is claimed is:

1-16. (canceled)

17. Method for filling a heat storage tank with solid elements having at least one first particle size and with solid elements having one second particle size, the first particle size being greater than the second particle size, said method comprising the following steps:
a) pouring a first quantity of solid elements of the first particle size into the tank,
b) levelling said first quantity of solid elements of the first particle size so as to form a layer of substantially constant height,
c) pouring a second given quantity of solid elements of the second particle size over the layer of solid elements of the first particle size such that the solid elements of the second particle size flow by gravity between the solid elements of the first particle size and such that the elements of the second particle size are flush with the layer of the solid elements of the first particle size and so as to form an intermediate layer,
steps a) to c) being repeated so as to form a stack of intermediate layers until a given height of solid elements is reached in the tank.

18. Method for filling according to claim 17, comprising a step d) of levelling the second quantity of solid elements of the second particle size, after each step c).

19. Method for filling according to claim 17, in which the ratio between the median of the first particle size and the median of the second particle size is comprised between 8 and 20.

20. Method for filling according to claim 19, in which the ratio between the median of the first particle size and the median of the second particle size is of the order of 10.

21. Method for filling according to claim 17, in which during step c) the solid elements of the second particle size are spread out over the whole layer of solid elements of the first particle size.

22. Method for filling according to claim 21, in which the solid elements of the second particle size are poured so as to spread them out homogeneously over the whole height of the layer of solid elements of the first particle size.

23. Method for filling according to claim 17, in which during filling there is no packing down, nor mechanical action.

24. Method for filling according to claim 1, in which the intermediate layer has a height of the order of 15 cm.

25. Method for filling according to claim 17, in which prior to step a) the solid elements of the first particle size are washed and dried.

26. Method for filling according to claim 17, in which prior to step c) the solid elements of the second particle size are washed and dried.

27. Method for filling according to claim 17, in which the first quantity corresponds to around 80% by weight of the intermediate layer and the second quantity corresponds to around 20% by weight of the intermediate layer.

28. Method for filling according to claim 17, in which the heat storage tank is a dual thermocline type tank.

29. Method for manufacturing a heat storage tank comprising the following steps:
manufacturing an assembly formed of a shell and a lower bottom,
filling according to the method according to claim 17,
putting in place an upper bottom to seal the tank in a leak tight manner,
filling with the heat transfer fluid.

30. Method of manufacturing a heat storage tank according to claim 29, in which the tank comprises at least two superposed compartments, each compartment comprises a bed of solid elements, each compartment being filled according to a method filling a heat storage tank with solid elements having at least one first particle size and with solid elements having one second particle size, the first particle size being greater than the second particle size, said method comprising the following steps:
a) pouring a first quantity of solid elements of the first particle size into the tank,
b) levelling said first quantity of solid elements of the first particle size so as to form a layer of substantially constant height,
c) pouring a second given quantity of solid elements of the second particle size over the layer of solid elements of the first particle size such that the solid elements of the second particle size flow by gravity between the solid elements of the first particle size and such that the elements of the second particle size are flush with the layer of the solid elements of the first particle size and so as to form an intermediate layer,
steps a) to c) being repeated so as to form a stack of intermediate layers until a given height of solid elements is reached in the tank.

31. Method of manufacturing according to claim 13, in which the solid elements of the first particle size are alluvial pebbles and the solid elements of the second particle size are silica based sand.

32. Method of manufacturing a heat storage tank according to claim 29, in which the heat transfer fluid is thermal oil, for example Therminol 66®.

33. Method of manufacturing a heat storage tank according to claim 32, in which the heat transfer fluid is Therminol 66®.
